(19) United States
(12) Patent Application Publication
(10) Pub. No.: US 2016/0085311 A1
(43) Pub. Date: Mar. 24, 2016

(54) CONTROL UNIT AND METHOD OF INTERACTING WITH A GRAPHICAL USER INTERFACE

(71) Applicant: Sony Corporation, Tokyo (JP)

(72) Inventors: Magnus Midholt, Lund (SE); Erik Westenius, Lund (SE); David de Leon, Lund (SE); Kåre Agardh, Lund (SE); Ola Thorn, Limhamn (SE)

(21) Appl. No.: 14/494,701

(22) Filed: Sep. 24, 2014

(51) Int. Cl. G06F 3/01; G06F 3/0484

(52) U.S. Cl. CPC G06F 3/017; G06F 3/04842

(57) ABSTRACT

A control unit includes an electric field sensor and a motion sensor. Signals from the electric field sensor and the motion sensor are interpreted to generate corresponding graphical user interface control signals for a graphical user interface displayed by a separate electronic device. The graphical user interface control signals include movement control signals for a moveable element of the graphical user interface that correspond to movement of the control unit and a select control signal that corresponds to detection of a change in electric field sensed by the electric field sensor that is indicative of a change in a physical configuration of a user's body part.

### TECHNICAL FIELD OF THE INVENTION

The technology of the present disclosure relates generally to electronic devices and, more particularly, to a wearable control unit that detects user movement to control interaction with a graphical user interface that is displayed on an electronic device.

### BACKGROUND

Electronic devices, such as mobile phones, computers including table computers, laptop computers and desktop computers, televisions, video game consoles, and the like have user inputs that are used in the control of the electronic device. Exemplary user inputs include touch sensitive displays, buttons, keyboards, mice, remote controls, and gaming controllers. But these user inputs can be cumbersome to use in some circumstances. Also, some user input devices include features to wake up the device from a power save state. Unfortunately, some wake-up features, such as those that rely on accelerometers, can consume relatively large amounts of power. Therefore, there remains room for improvement in the manner in which users interact with electronic devices and for reducing power consumption by electronic devices.

### SUMMARY

The disclosed control unit and related methods employ a static electric field sensor to detect variations in the electric field around the control unit. The control unit may be embodied as a wearable device that senses changes in electric field caused by movements of a user, such as changes in the configuration of a body part that results in a variation in a volume distribution of the body part. The sensed changes in electric field are used to activate functionality in the control unit and/or to conduct interaction with another electronic device. The interaction with another electronic device may include controlling graphical user interface functions.

According to one aspect of the disclosure, a control unit includes an electric field sensor configured to detect changes in static electric field at the control unit and output a signal corresponding to the detected changes; a motion sensor configured to detect movement of the control unit and output a signal corresponding to the detected movement; an interface configured to establish a communication link with an electronic device separate from the control unit; and a control circuit configured to interpret the signals from the electric field sensor and the motion sensor and generate corresponding graphical user interface control signals for a graphical user interface displayed by the electronic device, the graphical user interface control signals include movement control signals for a moveable element of the graphical user interface that correspond to movement of the control unit and a select control signal that corresponds to detection of a change in electric field sensed by the electric field sensor that is indicative of a change in a physical configuration of a user's body part, wherein the movement control signals and the select control signal are communicated to the electronic device via the interface.

According to one embodiment of the control unit, the control unit is worn by the user.

According to one embodiment of the control unit, the control unit is worn at the user's wrist.

According to one embodiment of the control unit, the change in physical configuration of the user's body part is a movement of the user's fingers into a first from a relaxed configuration or spreading apart of the user's fingers.

According to one embodiment of the control unit, the motion sensor includes a power save state and, when the motion sensor is in the power save state, detection of a change in electric field sensed by the electric field sensor that is indicative of a change in a physical configuration of the user's body part initiates a wake up of the motion sensor from the power save state.

According to one embodiment of the control unit, following the wake up of the motion sensor from the power save state, the change in physical configuration of the user's body part is verified by tremor detection made with the motion sensor.

According to one embodiment of the control unit, the control unit is used to control an electronic device that is located out of arm's reach of the user.

According to one embodiment of the control unit, a display of the electronic device is not touch-control enabled.

According to one embodiment of the control unit, the graphical user interface control signals further include a select control signal that corresponds to detection of a change in electric field sensed by the electric field sensor that is indicative of user touching of the display.

According to another aspect of the disclosure, a method of interacting with a graphical user interface of an electronic device using a control unit includes detecting changes in static electric field at the control unit with an electric field sensor of the control unit; detecting movement of the control unit with a motion sensor of the control unit; establishing a communication link between the control unit and the electronic device with an interface of the control unit; interpreting signals from the electric field sensor and the motion sensor with a control circuit of the control unit and generating corresponding graphical user interface control signals for a graphical user interface displayed by the electronic device, the graphical user interface control signals including movement control signals for a moveable element of the graphical user interface that correspond to movement of the control unit and a select control signal that corresponds to detection of a change in electric field sensed by the electric field sensor that is indicative of a change in a physical configuration of a user's body part; and communicating the movement control signals and the select control signal to the electronic device via the interface.

According to one embodiment of the method, the control unit is worn by the user.

According to one embodiment of the method, the control unit is worn at the user's wrist.

According to one embodiment of the method, the change in physical configuration of the user's body part is a movement of the user's fingers into a first from a relaxed configuration or spreading apart of the user's fingers.

According to one embodiment of the method, the motion sensor includes a power save state and, when the motion sensor is in the power save state, the method further includes initiating a wake up of the motion sensor from the power save state upon detection of a change in electric field sensed by the electric field sensor that is indicative of a change in a physical configuration of the user's body part.

According to one embodiment of the method, following the wake up of the motion sensor from the power save state, verifying the change in physical configuration of the user's body part by tremor detection made with the motion sensor.

According to one embodiment of the method, the control unit is used to control an electronic device that is located out of arm's reach of the user.

According to one embodiment of the method, a display of the electronic device is not touch-control enabled.

According to one embodiment of the method, the graphical user interface control signals further include a select control signal that corresponds to detection of a change in electric field sensed by the electric field sensor that is indicative of user touching of the display.

### BRIEF DESCRIPTION OF THE DRAWINGS

FIG. 1 is a schematic representation of an environment in which a control unit as described in this disclosure may be employed.

FIG. 2 is a schematic block diagram of the control unit.

FIG. 3 is a representation of the control unit in use when embodied in a wrist band form factor.

FIG. 4 is another representation of the control unit of FIG. 3.

FIG. 5 is a flow diagram illustrating an exemplary logic flow for operations carried out by the control unit.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below in conjunction with the appended figures are various embodiments of a control unit that enables a user to interact with a graphical user interface of an electronic device. To carry out certain operations, the control unit relies, in part, on detecting variations in electric field. The control unit is typically—but not necessarily—a wearable or hand-held electronic device. An exemplary form factor for the control unit is a wrist band similar to that of a watch or bracelet. Other exemplary form factors include a ring and a sleeve part of an article of clothing. In still other cases, the control unit may be worn or retained by another part of the user's body, such as the neck or leg.

Aspects of the control unit as a device that is configured to facilitate user interaction with a graphical user interface will be described. The control unit may have other functions that are not described in detailed. Components to support other functions of the control unit may be added. An exemplary additional function includes displaying information on a display of the control unit, such as text messages, email messages, calendar reminders, time and date, etc. Other exemplary functions may include, but are not limited to, outputting sounds and detecting speech for use as a wireless handsfree device, tracking user footsteps for use as a pedometer, tracking user heart rate or other conditions as a medical monitor or exercise aid, etc.

The electronic device that is controlled using the control unit is typically—but not necessarily—a mobile phone, a computing device, a television, a gaming console or other device. The control unit is used to manipulate features of a graphical user interface of the electronic device, such as moving a mouse pointer or cursor, selecting icons, dragging objects, and so forth.

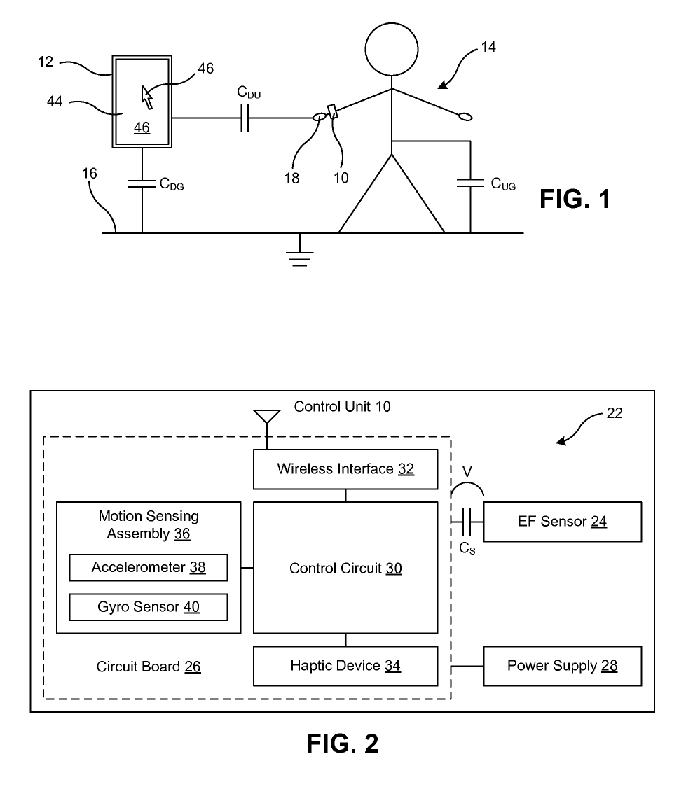

With initial reference to FIG. 1, illustrated is a schematic block diagram of an exemplary control unit 10 and electronic device 12 in an operational environment. The illustrated, exemplary operational environment includes a user 14 of the control unit 10 and the electronic device 12. Various electrical and magnetic fields are present around the control unit 10, the electronic device 12 and the user 14. These fields are generally generated by the flow of alternating current in cables, appliances, electronic devices, etc.

In addition to fields generated by alternating current, static electric fields are also present. The static field strength (or voltage potential) between two objects is dependent on the materials making up the objects, the relative position of the objects from one another, the distance between the objects, the relative movement between the objects, and any electrical connection or coupling to other objects in the environment.

To represent this electrical environment, capacitances between pairs of items in FIG. 1 are schematically illustrated. Each item has a capacitance relative to a ground plane 16, indicated by C_{UG} for the capacitance between the user 14 and the ground plane 16 and by C_{DG} for the capacitance between the electronic device 12 and the ground plane 16. Also, each item has a capacitance relative to each other, indicated by C_{DU} for the capacitance between the user 14 and the electronic device 12. Other capacitances exist, such as between the control unit 10 and the user 14 and between the control unit 10 and the ground plane 14.

Across each of these capacitances, a static electric field may be present. The electric field between any two of the objects in the environment may change. Thus, the total electric field as detectable at the control unit 10 may change. These changes may be due to movement of the user 14 relative to the control unit 10, movement of the control unit 10 relative to the electronic device 12, and movement of the user 14 relative to the electronic device 12. The movements that cause changes in detectable electric field may be large-scale movements, such as the user 14 walking past the electronic device 12, or relatively small scale movements, such as the user 14 moving an arm in a reaching motion.

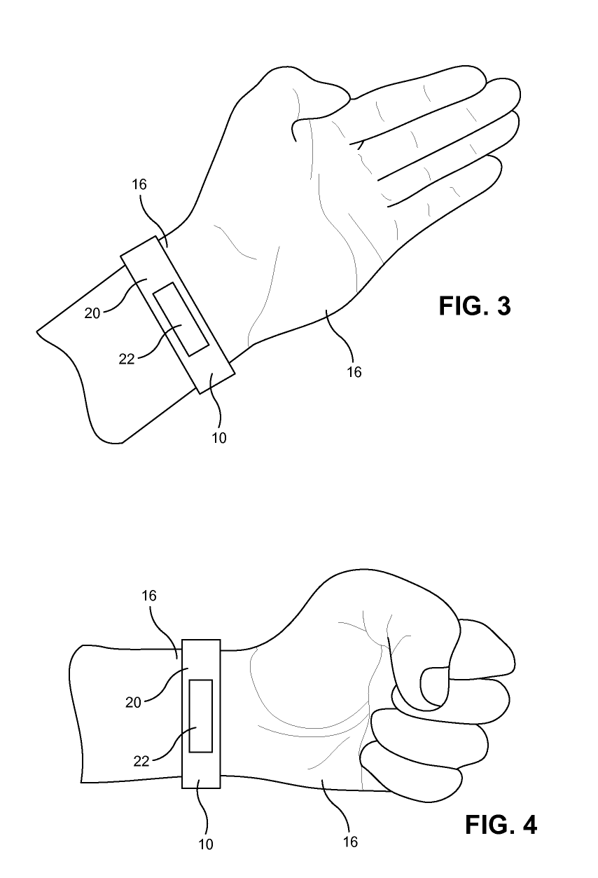

With additional reference to FIGS. 3 and 4, relatively small movements may result in a change in electric field. For example, changes in the configuration of the user's hand 16 (inclusive of the fingers) may result in a detectable change in electric field in the case where the control unit 10 is worn around a wrist 18 of the user. In this embodiment, the control unit 10 may include a strap 20 that retains an electronics module 22, details of which will be described below.

Certain movements may be associated with predictable changes in electric field. For instance, each time the user 14 changes the volumetric configuration of his or her hand 16 from an open palm configuration as shown in FIG. 3 to a closed first configuration as shown in FIG. 4, a corresponding change in electric field that is detectable by the control unit 10 may result. For instance, this movement may result in an increase in electric field strength.

Thus, it will be understood that materials and objects in an environment with electrical fields have voltage potentials towards other objects in the surrounding environment. More specifically, as soon as there is a voltage potential or current flowing near the control unit 10, there will be an electrical field or fields generated in the location of the control unit 10. But the detectable electric field strength is affected by varying voltage potentials between objects, and those potentials changes depending on factors such as user body size, user movement (e.g., walking, raising or lowering an arm, etc.), distance between objects (e.g., distance and arrangement of the user's fingers relative to the control unit 10), and other factors.

Referring now to FIGS. 1 and 2, the electronics module 22 of the control unit 10 includes an electric field (EF) sensor 24. In one embodiment, the EF sensor 24 is capacitively coupled to a circuit board 26 to which other electrical components (described below) of the control unit 10 are mounted. The capacitive coupling may be established with a capacitor or by separation of the EF sensor 24 and the circuit board 26 by an insulating medium. The capacitive coupling between the EF sensor 24 and the circuit board 26 is represented by Cₛ and a voltage potential between the EF sensor 24 and the circuit board 26 is represented by V.

In the embodiment of a wrist-worn control unit 10, the EF sensor 24 is preferably located on the ventral side of the wrist toward the user's hand 16 to improve detection of electric field fluctuations caused by movement and changes in the configuration of the user's hand. Since the relative permittivity of the hand 16 is different from that of air, the amplitude of the detected electric field will vary when the volume distribution of the user's hand 16 is varied such as by movement of the user's fingers. In this manner, the transition between at least two basic gestures is determinable from changes in electric field. The two basic gestures may be an open-palm configuration of the user's hand (also referred to as a relaxed state) and a closed configuration (e.g., a fist-like configuration) of the user's hand (also referred to as an unrelaxed state). The open-palm state may include the fingers being deployed relatively rigidly and “straight out” along the longitudinal axis of the user's forearm. The open-palm state also may include other configurations, such as the user's fingers being in a more neutral state with the fingers slightly curled.

In one embodiment, a transition to a third state may be determinable. For example, the relaxed state may involve spacing the user's fingers relatively close together, such as touching each other as shown in FIG. 3 or in a more neutral state with the fingers spaced slightly apart. A third state may be where the user purposefully spreads his or her fingers apart. Movement between the relaxed state and this third state may result in a corresponding change in electric field that is detectable and used as a control input.

Forming a first and spreading apart of the user's fingers are just two example configuration changes that result in detectable changes in electric field and/or tremors. As such, these actions may be considered gestures that may be used in the disclosed techniques. Other gestures or actions also may be used. For instance, the user straining his or her muscles without significant movement may result in a detectable tremor change. Moreover, the change in a physical configuration of a user's body part need not occur with respect the user's hand. Other changes may involve movement at one or more of the hand, the elbow, the shoulder, the wrist, the knee, the hip, the ankle, the torso, the head and neck, or the jaw. In this respect, gestures involving motion that cause the sensed electric field to change and/or trigger output by the accelerometer 38 may be used as a type of user input. The changes in electric field may result from movement of the user's body part relative the control unit 10 (regardless of where on the body the control unit 10 is worn) and/or due to movement of the user's body part relative to other objects, such as but not limited to the electronic device 12. As such, actions involving reconfiguration of one or more than one body part may be used as gestures that invoke response by the control unit 10. Examples include, but are not limited to, bowing at the waist, grabbing and pulling or grabbing and pushing (which are gestures involving a combination of two body parts moving, including a hand movement to grab and an arm movement to pull or push), pushing outward with an open palm (involves movement of multiple body parts), lifting by bending an elbow, etc. The detections made by both the EF sensor 24 and the accelerometer 38 may be used alone or in combination to distinguish one gesture from other gestures.

A relatively simple way of implementing the EF sensor 24 and measuring electrical fields includes using a standard radio receiver used to receive broadcast transmissions (e.g., AM or FM transmissions). Another embodiment of implementing the EF sensor 24 and measuring electrical fields includes using an antenna and a sensing circuit. The power consumption of an EF sensing function implement in one of these manners is relatively low (e.g., as low as a couple of milliWatts).

An exemplary embodiment of the EF sensor 24 includes an EF antenna, a voltage meter (also referred to as a voltmeter) and a capacitor (e.g., capacitor Cₛ implemented with a physical circuit component). The capacitor has a first pole connected to the EF antenna and a second pole connected to a reference potential on the circuit board 26. The voltage meter measures the voltage across the capacitor and outputs an analog electrical signal indicative of variations in the electric field surrounding the control unit 10. The analog signal from the voltmeter may be converted to a digital signal using an analog to digital (A/D) converter. The digital signal may be analyzed using digital signal processing and statistical analysis to identify and classify features and variations of the sensed electric field. Continuous or periodic scanning of the EF environment may be made with relative low power consumption (e.g., up to a few milliWatts). EF sensing may consume as little as 1.8 MicroAmps for sensing activity. Therefore, application of the EF sensor 24 may be made in wearable and portable electronic devices that typically operate using power from rechargeable batteries that form part of a power supply 28.

The control unit 10 includes a control circuit 30 that is responsible for overall operation of the control unit 10, including controlling the control unit 10 in response to detections made by the EF sensor 24. The control circuit 30 may include any appropriate processing components and memory components to implement the functionality of the control unit 10, which may be embodied as software or firmware.

The control unit 10 includes a wireless interface 32 used to establish an operative communications connection with the electronic device 12. Control input may be communicated from the control unit 10 to the electronic device 12 over the communications connection. Exemplary wireless interfaces 32 include, but are not limited to, a Bluetooth interface and a WiFi interface.

The control unit 10 may include one or more user inputs for receiving user input for controlling operation of the control unit 10. Exemplary user inputs include, but are not limited to, the touch sensitive input, one or more buttons, etc.

The control unit 10 may include one or more user feedback components. For instance, the control unit 10 may include a haptic device 34 that provides haptic feedback to the user in certain situations, such as moving a cursor against a boundary of a display or selecting a selectable item displayed as part of a graphical user interface.

The control unit 10 includes one or more motion sensors 36. One exemplary motion sensor 36 is an accelerometer assembly 38 that is configured to detect acceleration along one, two or three axes and provide output signals that may be interpreted to ascertain motion of the control unit 10. Another exemplary motion sensor 36 is a gyro sensor 40. Other items that may be configured and used as motion sensors 36 includes a camera, an IR sensor, etc.

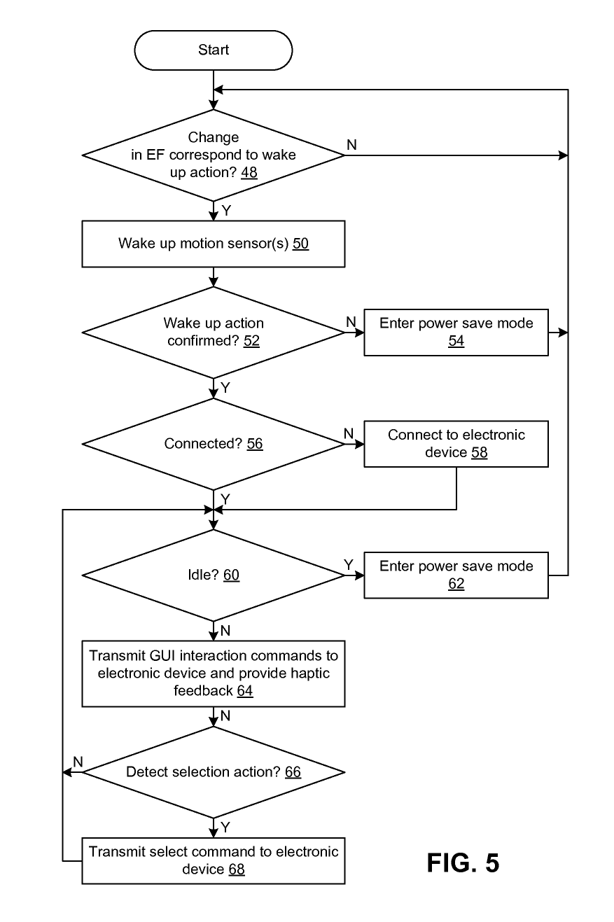

With additional reference to FIG. 5, illustrated is an exemplary flow diagram representing steps that may be carried out by the control unit 10 to implement control of the electronic device 12. Although illustrated in a logical progression, the illustrated blocks may be carried out in other orders and/or with concurrence between two or more blocks. Therefore, the illustrated flow diagram may be altered (including omitting steps) and/or may be implemented in an object-oriented manner or in a state-oriented manner.

The following descriptions will be made in the context of using the accelerometer 38 for motion sensing. But it will be appreciated that motion sensing alternatively may be made with different components, such as the gyro sensor 40 and/or the EF sensor 24, or may be made by fusion sensing using signals from the accelerometer 38 and one or more other components, such as the gyro sensor 40 and/or the EF sensor 24.

Exemplary control over the electronic device 12 includes interacting with a graphical user interface (GUI) 42 (FIG. 1) that is displayed on a display 44 (FIG. 1) of the electronic device 12. The GUI 42 may include a cursor 46 (FIG. 1) or other object that is configured to move around the display 44. Other GUI items may include selectable objects, icons, messages, text, graphics, and so forth.

The logical flow may commence in a state where the control unit 10 is in a power save state. In this state, the motion sensors 36 (e.g., the accelerometer 38) may be in a power save or an off state, but the EF sensor 24 may be in an active state to detect changes in electric field.

In block 48, the control unit 10 monitors output from the EF sensor 24 to determine if a detected change in electric field corresponds to a wake up action. In the illustrated embodiment where the control unit 10 is worn at the wrist of the user 14, the wake up action may be making a first by curling the fingers and thumb inward toward the user's palm (e.g., as shown in FIG. 4). The making of a first from a more relaxed state, such as the open-palm state of FIG. 3, changes the configuration (e.g., volume distribution) of the user's hand. The change in configuration results in a corresponding change in electric field at the control unit 10. This change may be detected and identified, which leads to a positive determination in block 48.

Upon a positive determination in block 48, the logical flow may proceed to block 50.

In block 50, the accelerometer 38 is woken up and motion sensing with the accelerometer 38 is made. Next, in block 52, the occurrence of the wake up action is confirmed. Confirmation may be made by analyzing signals generated by the accelerometer 38 for a tremor signature corresponding to muscle strain associated with making a fist. Tremor detection (or hand shake detection) is understood in the art, and it will be recognized that the tremor signature made by the user's hand 16 when relaxed (e.g., as shown in FIG. 3) will be different than when in a first configuration (e.g., as shown in FIG. 4). If a negative determination is made in block 52, then the accelerometer 38 may return to the power save state in block 54 and the logical flow will return to block 48.

Following a positive determination in block 52, the logical flow may proceed to block 56. In block 56, a determination may be made as to whether the control unit 10 has an operative communication link established with the electronic device 12. If not, the logical flow may proceed to block 58. In block 58, the wireless interface 32 may be used to establish the communication link with the electronic device 12. It will be appreciated that the link between the control unit 10 and the electronic device 12 may be previously established. During establishment of the connection, the electronic device 10 may transmit size and/or aspect ratio data to the control unit 10. This information may be used in the generation of cursor control or other GUI interface commands in order to optimize and/or coordinate the motor space of the control unit 10 with the GUI 42. Following block 58 or a positive determination in block 56, the logical flow may proceed to block 60.

In block 60, a state determination is made as to whether the control unit 10 is idle. An idle state may be a detection that no movement of the control unit 10 related to interacting with the GUI 42 of the electronic device 12 is detected for a predetermined period of time such as twenty seconds, thirty seconds, one minute or five minutes. Following a positive determination in block 60, the accelerometer 38 may return to the power save state in block 62 and the logical flow will return to block 48.

If the control unit 10 is not in an idle state, then movement of the control unit 10 may be tracked using output of the accelerometer 38 in block 64. GUI 42 interaction commands may be determined from the movement and transmitted to the electronic device 12. Exemplary GUI 42 interaction commands may include cursor 46 movement commands that coordinate with guided movement of the control unit 10 caused by movement of the user's arm and/or hand 16. In one embodiment, if the user's hand 16 is in a relaxed state (e.g., the open palm configuration of FIG. 3), then movement of the control unit 10 may be interpreted as user movement to make corresponding cursor 46 movements on the display 44. Also, if the user's hand 16 is in an unrelaxed state (e.g., the first configuration of FIG. 4), then movement of the control unit 10 may be interpreted as user movement to drag a selected object or portion of the GUI 42.

In an embodiment where motion of the control unit 10 controls motion of the cursor 46 (or other object), the signals from the accelerometer 38 may be converted to cursor 46 control signals. In this manner, vertical movements of the control unit 10 (e.g., up and down movements) result in corresponding vertical movements of the cursor 46 and horizontal movements of the control unit 10 (e.g., lefts and right movements) result in corresponding horizontal movements of the cursor 46. Vertical and horizontal vector components of sensed movement of the control unit 10 may be combined to achieve diagonal and non-linear movement of the cursor 46. Forward and backward movements away from and toward the user's body also may be used to effect other interaction with the GUI 42 including, for example, “pushing” an object or selecting an object.

During interaction with the GUI 42 using the control unit 10, the control unit 10 may provide feedback to the user 14. An exemplary type of feedback is haptic feedback produced by the haptic device 34. For example, if the user 14 were to control movement of the cursor 46 and the cursor 46 were to come to an edge of the display 44, then haptic feedback may be made to mimic the sense of physically coming into contact with a boundary. Haptic feedback may be used in other situations, such as when the cursor 46 moves over a selectable item or link, or when successful selection of an item or link is made.

Continuing with the logical flow, in block 66, the control unit 10 may monitor for a select action made by the user 14. In one embodiment, GUI interaction such as moving a cursor is made with the user's hand 16 in a relaxed state. During this time, if one or both of the outputs from the EF sensor 24 (e.g., change in electric field) or the accelerometer 38 (e.g., tremor peak) indicate that the user 14 has reconfigured his or her fingers to the unrelaxed, fist-shaped state, then a selection action may be detected. If a selection action is detected in block 66, the logical flow may proceed to block 68 where a select command is transmitted to the electronic device 12. In one embodiment, the select action may not be completed until the user returns his or her hand to the relaxed state. The selection action is operative at the position of the cursor 46 or other GUI 42 element that is controlled by movement of the control unit 10. Following block 68 or a negative determination in block 66, the logical flow may return to block 60.

The select actions may be similar to using a mouse button where transitioning from a relaxed state to an unrelaxed state is similar to depressing the mouse button and transitioning back to the relaxed state from the unrelaxed state is similar to releasing the mouse button. If carried out twice, these actions may simulate a double-click action of a mouse button. These actions also may be made to simulate interaction with a touch screen. For example, transitioning from a relaxed state to an unrelaxed state is similar to touching the screen with a fingertip and transitioning back to the relaxed state from the unrelaxed state is similar to removing the fingertip from the screen.

It will be appreciated that other gestures made by the user will result in corresponding activity carried out by the electronic device 12. Other exemplary gestures are described above. The disclosed control unit 10 and GUI 42 interaction techniques allow a user to operatively interact with displayed content on the electronic device 12 or other controllable aspects of the electronic device 12. This interaction may be carried out even when the device is touch enabled, but is out of reach of the user 14.

The disclosed techniques may be employed with touch-enabled electronic devices and electronic devices that are not touch enabled. In the situation where the display 44 of the electronic device 12 is not touch enabled, the cursor 46 may be moved as described and the user may select an item as described. The user may further select an item by physically tapping the display 44 as if it were touch enabled. The tap will result in a change in electric field by the user physically coming into contact with the display 44 and thus changing the capacitance C_{UD}. This change may be sensed by the EF sensor 24 and used to generate a select command. The location of the tap is coordinated with the cursor location that is tracked with control unit 10 motion as described. In another embodiment, the forward motion of the user and physical interaction of a fingertip with the display may be detected with the accelerometer 38. But it is contemplated that tap detection with the EF sensor 24 may have better performance. This is because the accelerometer 38, in this situation, may be prone to misreading the tap action since the detectable accelerations resulting from the tap are propagated through a considerable amount of deformable tissue of the user between the fingertip and the wrist 18 where the control unit 10 is located.

Although certain embodiments have been shown and described, it is understood that equivalents and modifications falling within the scope of the appended claims will occur to others who are skilled in the art upon the reading and understanding of this specification.

1. A control unit, comprising:
an electric field sensor configured to detect changes in static electric field at the control unit and output a signal corresponding to the detected changes;
a motion sensor configured to detect movement of the control unit and output a signal corresponding to the detected movement;
an interface configured to establish a communication link with an electronic device separate from the control unit; and
a control circuit configured to interpret the signals from the electric field sensor and the motion sensor and generate corresponding graphical user interface control signals for a graphical user interface displayed by the electronic device, the graphical user interface control signals include movement control signals for a moveable element of the graphical user interface that correspond to movement of the control unit and a select control signal that corresponds to detection of a change in electric field sensed by the electric field sensor that is indicative of a change in a physical configuration of a user's body part, wherein the movement control signals and the select control signal are communicated to the electronic device via the interface.

2. The control unit of claim 1, wherein the control unit is worn by the user.

3. The control unit of claim 2, wherein the control unit is worn at the user's wrist.

4. The control unit of claim 1, wherein the change in physical configuration of the user's body part is a movement of the user's fingers into a first from a relaxed configuration or spreading apart of the user's fingers.

5. The control unit of claim 1, wherein the motion sensor includes a power save state and, when the motion sensor is in the power save state, detection of a change in electric field sensed by the electric field sensor that is indicative of a change in a physical configuration of the user's body part initiates a wake up of the motion sensor from the power save state.

6. The control unit of claim 5, wherein following the wake up of the motion sensor from the power save state, the change in physical configuration of the user's body part is verified by tremor detection made with the motion sensor.

7. The control unit of claim 1, wherein the control unit is used to control an electronic device that is located out of arm's reach of the user.

8. The control unit of claim 1, wherein a display of the electronic device is not touch-control enabled.

9. The control unit of claim 8, wherein the graphical user interface control signals further include a select control signal that corresponds to detection of a change in electric field sensed by the electric field sensor that is indicative of user touching of the display.

10. A method of interacting with a graphical user interface of an electronic device using a control unit, comprising:
detecting changes in static electric field at the control unit with an electric field sensor of the control unit;
detecting movement of the control unit with a motion sensor of the control unit;
establishing a communication link between the control unit and the electronic device with an interface of the control unit;
interpreting signals from the electric field sensor and the motion sensor with a control circuit of the control unit and generating corresponding graphical user interface control signals for a graphical user interface displayed by the electronic device, the graphical user interface control signals including movement control signals for a moveable element of the graphical user interface that correspond to movement of the control unit and a select control signal that corresponds to detection of a change in electric field sensed by the electric field sensor that is indicative of a change in a physical configuration of a user's body part; and
communicating the movement control signals and the select control signal to the electronic device via the interface.

11. The method of claim 10, wherein the control unit is worn by the user.

12. The method of claim 11, wherein the control unit is worn at the user's wrist.

13. The method of claim 10, wherein the change in physical configuration of the user's body part is a movement of the user's fingers into a first from a relaxed configuration or spreading apart of the user's fingers.

14. The method of claim 10, wherein the motion sensor includes a power save state and, when the motion sensor is in the power save state, the method further comprises initiating a wake up of the motion sensor from the power save state upon detection of a change in electric field sensed by the electric field sensor that is indicative of a change in a physical configuration of the user's body part.

15. The method of claim 14, wherein following the wake up of the motion sensor from the power save state, verifying the change in physical configuration of the user's body part by tremor detection made with the motion sensor.

16. The method of claim 10, wherein the control unit is used to control an electronic device that is located out of arm's reach of the user.

17. The method of claim 10, wherein a display of the electronic device is not touch-control enabled.

18. The method of claim 17, wherein the graphical user interface control signals further include a select control signal that corresponds to detection of a change in electric field sensed by the electric field sensor that is indicative of user touching of the display.
